(19) United States
(12) Patent Application Publication
(10) Pub. No.: US 2012/0007465 A1
(43) Pub. Date: Jan. 12, 2012

(54) ELECTRIC MACHINE HAVING MULTIDIRECTIONAL SKEW

(75) Inventors: Richard N. Fargo, Plainville, CT (US); Stephen R. Nichols, Unionville, CT (US); Zbigniew Piech, Cheshire, CT (US)

(73) Assignee: OTIS ELEVATOR COMPANY, Farmington, CT (US)

(21) Appl. No.: 13/257,828

(22) PCT Filed: Mar. 27, 2009
(86) PCT No.: PCT/US09/38557

§ 371 Date: Sep. 20, 2011

(51) Int. Cl. H02K 1/16

(52) U.S. Cl. 310/216.069

(57) ABSTRACT

An electric machine includes a rotor rotatable about a central axis. The rotor includes at least one rotor element having a first element edge. A stator includes a stator face facing the rotor and a plurality of stator slots. Each stator slot has at least one stator slot edge located at the stator face. A first edge portion of the at least one stator slot edge is oriented nonparallel to the first element edge in a first direction and a second edge portion of the at least one stator slot edge is oriented nonparallel to the first element edge in a second direction.

### BACKGROUND OF THE INVENTION

The subject matter disclosed herein relates to electric machines. More particularly, the subject matter disclosed herein relates to skewing of electric machines.

In a typical electric machine, the stator slots and rotor magnets are aligned substantially parallel to the axis of the machine. As the rotor moves relative to the stator and, for example, the edge of a rotor magnet passes a stator slot, the machine experiences a number of problems including noise, flux disturbances, and vibration. To alleviate these issues, as shown in FIG. 9, some machines employ skew of the stator slots 126 and or the rotor magnets 124. In a stator 112, this is accomplished by setting the stator slots 126 at an angle relative to the machine axis 116, and similarly in a rotor an edge 132 of the rotor magnet 124 may be disposed at an angle to the machine axis 116. In doing so, when the rotor moves relative to the stator, a reduced length of the rotor magnet edge passes the stator slot edge at a given time thus improving cogging torque and torque ripple of the machine and reducing noise, flux disturbances and vibration.

The typical skewed machine, however, has the disadvantages of reducing the overall torque of the machine. Further, the skewed machine causes additional forces to be exerted on the bearing and support of a cantilevered rotor. In a non-skewed machine, forces on the bearings result perpendicular to the axis of the machine. In a skewed machine, however, an axial component of force on the bearing is introduced which limits the functional life of the bearing. The art would well receive an electric machine which provides the benefits of a typical skewed machine while minimizing the axial forces and decreasing the pulsation and torque reductions common in skewed machines.

### BRIEF DESCRIPTION OF THE INVENTION

According to one aspect of the invention, an electric machine includes a rotor rotatable about a central axis. The rotor includes at least one rotor element having a first element edge. A stator includes a stator face facing the rotor and a plurality of stator slots. Each stator slot has at least one stator slot edge located at the stator face. A first edge portion of the at least one stator slot edge is oriented nonparallel to the first element edge in a first direction and a second edge portion of the at least one stator slot edge is oriented nonparallel to the first element edge in a second direction.

According to another aspect of the invention, a stator for an electric machine includes a stator face and a plurality of stator slots located at the stator face and arranged around a central axis of the stator. Each stator slot has at least one stator slot edge, a first edge portion of the at least one stator slot edge oriented nonparallel to the central axis in a first direction and a second edge portion of the at least one stator slot edge is oriented nonparallel to the central axis in a second direction.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a cross-sectional view of an embodiment of an electric machine;

FIG. 2 is another cross-sectional view of an embodiment of an electric machine;

FIG. 3 is a plan view of an embodiment of a stator slot of the electric machine of FIG. 1;

FIG. 4 is a plan view of another embodiment of a stator slot of the electric machine of FIG. 1;

FIG. 5 is a plan view of yet another embodiment of a stator slot of the electric machine of FIG. 1;

FIG. 6 is a plan view of an embodiment of a rotor magnet of the electric machine of FIG. 1;

FIG. 7 is a plan view of another embodiment of a rotor magnet of the electric machine of FIG. 1;

FIG. 8 is a plan view of yet another embodiment of a rotor magnet of the electric machine of FIG. 1; and

FIG. 9 is a plan view of a prior art machine illustrating single-directional skew.

The detailed description explains embodiments of the invention, together with advantages and features, by way of example with reference to the drawings.

### DETAILED DESCRIPTION OF THE INVENTION

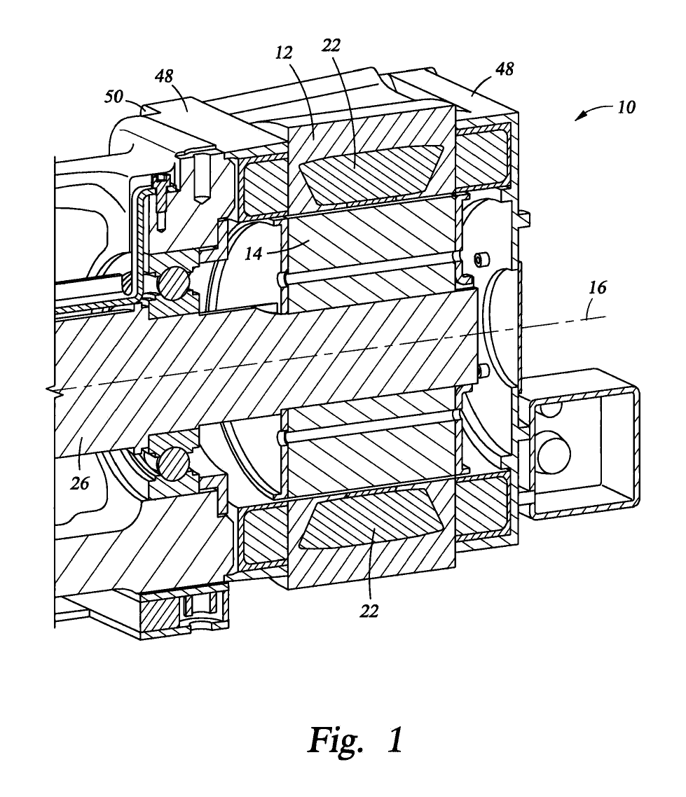

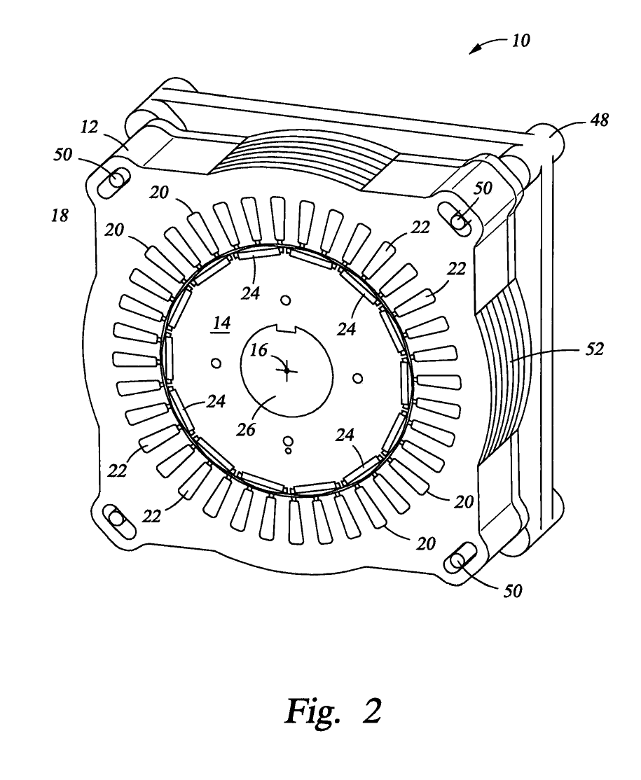

Shown in FIGS. 1 and 2 is an embodiment of an electric machine 10. The electric machine 10 includes a stator portion 12 and a rotor portion 14. The rotor portion 14 is rotatable about a machine central axis 16 relative to the stator portion 12 producing a torque and/or, in some embodiments, electric energy. The stator portion 12 is separated from the rotor portion 14 by an air gap 18. In the embodiments illustrated in FIGS. 1 and 2, the stator portion 12 is disposed radially outboard of the rotor portion 14, but it is to be appreciated that the stator portion 12 may be disposed radially inboard of the rotor portion 14. Further, the rotor portion 14 and stator portion 12 may be disposed axially adjacent to each other, resulting in an air gap 18 that is substantially axial. The stator portion 12 includes a plurality of stator slots 20. Each stator slot 20 is configured to be receivable of at least one conductor 22, which in some embodiments is a copper wire. In some embodiments, an electrical current is introduced to the at least one conductor 22. The current creates a magnetic field which interacts with one or more rotor elements, which in some embodiments are one or more permanent magnets 24, disposed at the rotor portion 14. The interaction drives a rotation of the rotor portion 14 about the central axis 16 which imparts a torque on a shaft 26 in operable communication with the rotor portion 14.

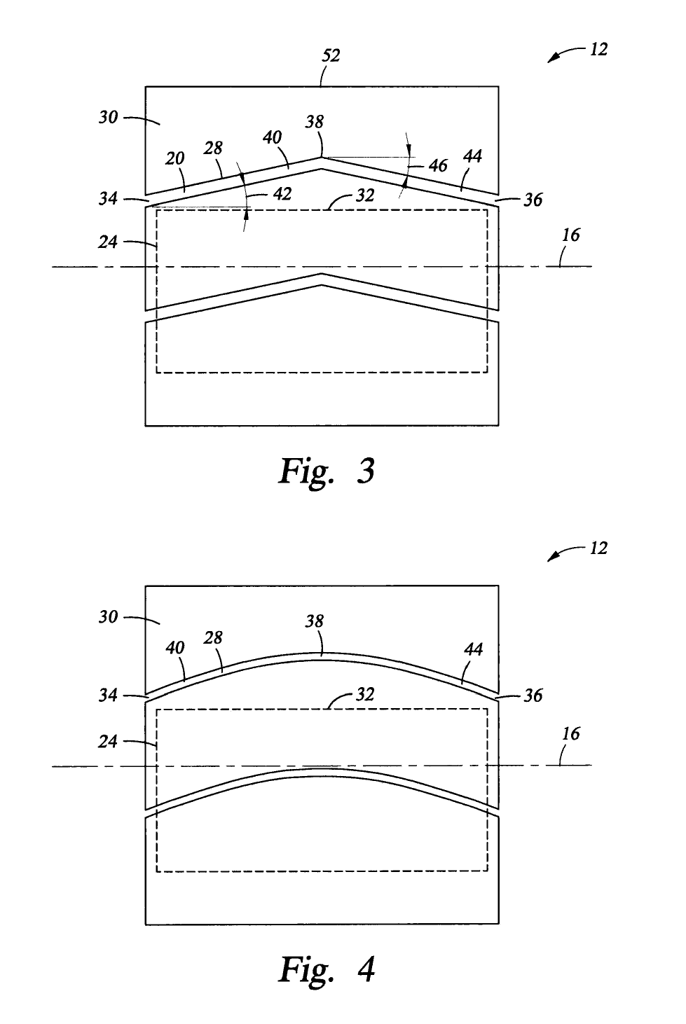

Referring now to FIG. 3, each stator slot 20 is configured such that at least one stator slot edge 28 disposed at a stator face 30 is nonparallel to a first magnet edge 32 of each permanent magnet 24. In some embodiments, each stator slot edge 28 has a first slot end 34 and a second slot end 36 with at least one transition 38 disposed therebetween. The at least one transition 38 is disposed such that it is not located on a line extended from the first slot end 34 to the second slot end 36. Thus, a first slot portion 40 extends from the first slot end 34 to the at least one transition 38 in a first direction skewed to the central axis 16 at an angle 42 and a second slot portion 44 extends from the transition 38 to the second slot end 36 in a second direction also skewed to the central axis 16 at an angle 46, which in some embodiments is substantially opposite to angle 42. As shown in FIG. 3, the first slot portion 40 and the second slot portion 44 are substantially linear and the transition 38 is a corner at an intersection of the first slot portion 30 and the second slot portion 44. In other embodiments, as shown in FIG. 4, the first slot portion 40 and/or the second slot portion 44 are curved along their respective lengths and the transition 38 may also be a curved shape connecting the first slot portion 40 and the second slot portion 44. Curved first and second slot portions 40/44 and the curved transition 38 minimize sharp changes in direction and facilitate ease of installation of the at least one conductor 22 therein.

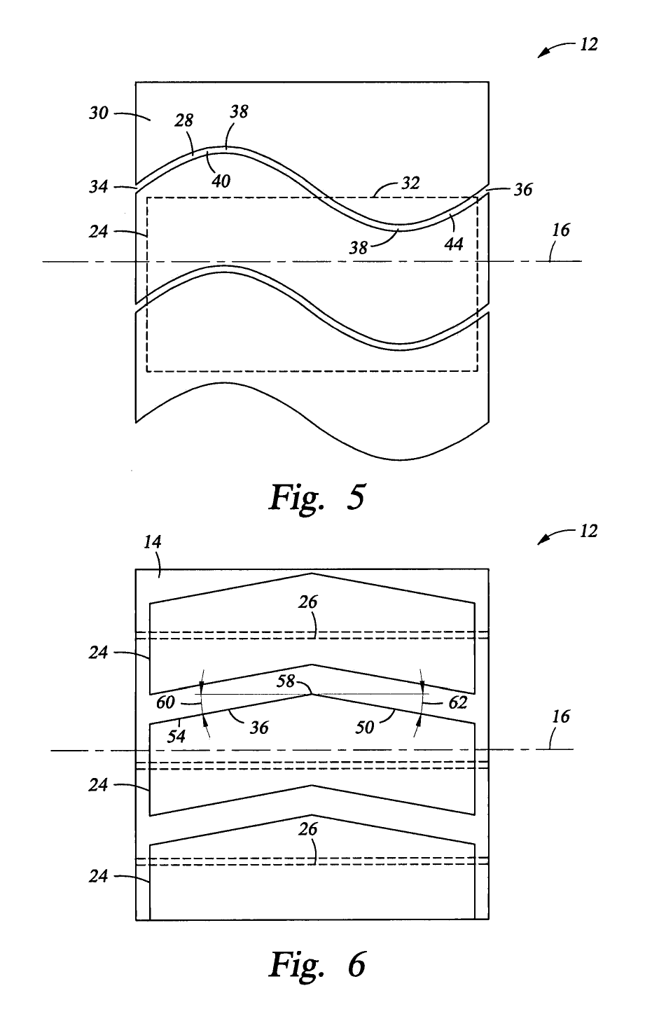

In some embodiments, as shown in FIG. 5, the each stator slot 20 may comprise multiple transitions 38, for example 2, 3 or 4 transitions 38 such that the skew of the stator slot 20 reverses multiple times over the length of the stator slot 20. As shown, the stator slot 20 may be substantially sinusoidally-shaped over its length.

Referring again to FIG. 1, the stator portion 12 is secured between endplates 48 by, for example threaded fasteners 50. As best shown in FIG. 3, in some embodiments, the stator portion 12 comprises a plurality of stacked stator laminations 52. To accomplish a desired skew, individual stator laminations 52 are shifted relative to adjacent stator laminations, in some embodiments rotated about the central axis 16, to provide a desired alignment between adjacent stator laminations 52 resulting in the desired skew. Referring again to FIG. 1, by reversing the skew at the transition 38, the stator laminations 52 adjacent to both endplates 48 will align with the endplates 48.

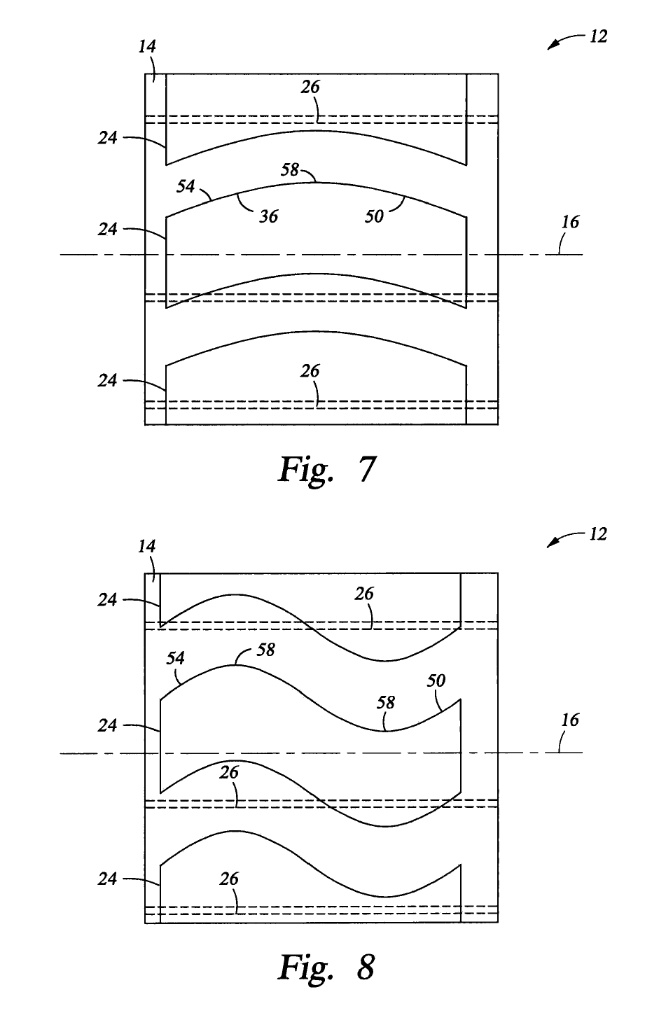

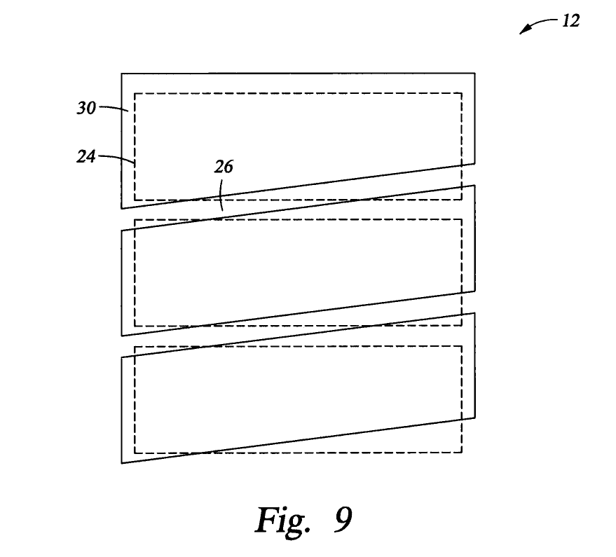

In some embodiments, as shown in FIG. 6, the permanent magnets 24 of the rotor portion 14 may be skewed in addition to, or instead of, the skew of the stator slots 20. As shown, the first magnet edge 32 of each permanent magnet 24 extends along the central axis 16 and comprises a first magnet segment 54 and a second magnet segment 56 joined by at least one magnet transition 58. The first magnet segment 54 extends to the at least one magnet transition 58 in a first direction skewed to the central axis 16 at an angle 60 and the second magnet segment 56 extends from the magnet transition 58 in a second direction also skewed to the central axis 16 at an angle 62, which in some embodiments is substantially opposite to angle 60. As shown in FIG. 6, the first magnet segment 54 and the second magnet segment 56 are substantially linear and the magnet transition 58 is a corner at an intersection of the first magnet segment 54 and the second magnet segment 56. In other embodiments, as shown in FIG. 7, the first magnet segment 54 and/or the second magnet segment 56 are curved along their respective lengths and the magnet transition 58 may also be a curved shape connecting the first magnet segment 54 and the second magnet segment 56. As with the stator slots 20, some embodiments, as shown in FIG. 8, may include multiple magnet transitions 58, for example 2, 3 or 4 magnet transitions 58 such that the skew of the permanent magnet 24 reverses multiple times over the length of the permanent magnet 24. As shown, the first magnet edge 32 may be substantially sinusoidally-shaped over its length.

Changing or reversing the skew of the stator slots 20 and/or the permanent magnets 24 over the length of the machine 10 reduces a length of the permanent magnet 24 passing an edge of the stator slot 20 at any one instance during rotation of the rotor portion 14, thus improving cogging torque and torque ripple of the machine and reducing noise, flux disturbances and vibration. Further, the multidirectional skew reduces an axial pulsation of the machine 10 relative to a motor having uni-directional skew. Local axially-directed forces are generated between the permanent magnets 24 and the stator slots 20, but because of the reversal in direction of the skew, the local forces balance resulting in a net axial force that is substantially reduced. Reduction of the axial components of forces reduces forces acting on bearings 60 disposed at each end of the rotor portion 14.

It is to be appreciated that, while the embodiments described above apply multidirectional skew to an electric machine 10 where the rotor portion 14 includes permanent magnets 24, multidirectional skew may also be applied to other types of motors, for example, induction motors.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An electric machine comprising:
a rotor rotatable about a central axis and including at least one rotor element having a first element edge; and
a stator including:
a stator face facing the rotor; and
a plurality of stator slots, each stator slot having at least one stator slot edge disposed at the stator face, a first edge portion of the at least one stator slot edge disposed nonparallel to the first element edge in a first direction and a second edge portion of the at least one stator slot edge disposed nonparallel to the first element edge in a second direction.

2. The machine of claim 1 wherein the first direction is substantially opposite the second direction relative to the first element edge.

3. The machine of claim 1 wherein the first edge portion and/or the second edge portion are substantially curvilinear.

4. The machine of claim 1 wherein the at least one stator slot includes at least one transition disposed between the first edge portion and the second edge portion.

5. The machine of claim 4 wherein the at least one transition is substantially curvilinear in shape.

6. The machine of claim 1 wherein the at least one stator slot edge comprises an undulating shape of at least one period in length.

7. The machine of claim 1 wherein the stator is disposed radially outboard from the rotor.

8. The machine of claim 1 wherein the stator is disposed radially inboard from the rotor.

9. The machine of claim 1 wherein the first element edge comprises:
a first element edge portion;
a second element edge portion; and
at least one element transition disposed therebetween.

10. The machine of claim 9 wherein the first element edge portion and/or the second element edge portion are substantially curvilinear.

11. The machine of claim 9 wherein the at least one element transition is substantially curvilinear in shape.

12. The machine of claim 1 wherein the first element edge comprises an undulating shape of at least one period in length.

13. The machine of claim 1 wherein the rotor element is a permanent magnet.

14. A stator for an electric machine comprising:
a stator face; and
a plurality of stator slots disposed at the stator face and arranged around a central axis of the stator, each stator slot having at least one stator slot edge, a first edge portion of the at least one stator slot edge disposed nonparallel to the central axis in a first direction and a second edge portion of the at least one stator slot edge disposed nonparallel to the central axis in a second direction

15. The stator of claim 14 wherein the first direction is substantially opposite the second direction relative to the central axis.

16. The stator of claim 14 wherein the first edge portion and/or the second edge portion are substantially curvilinear.

17. The stator of claim 14 wherein the at least one stator slot includes at least one transition disposed between the first edge portion and the second edge portion.

18. The stator of claim 17 wherein the at least one transition is substantially curvilinear in shape.

19. The stator of claim 14 wherein the at least one stator slot comprises an undulating shape of at least one period in length.

20. An electric machine substantially as described herein and illustrated with reference to the accompanying drawings.
